(19) United States
(12) Patent Application Publication
(10) Pub. No.: US 2009/0106011 A1
(43) Pub. Date: Apr. 23, 2009

(54) SYSTEM AND METHOD FOR DEVELOPING AND DEPLOYING SENSOR AND ACTUATOR APPLICATIONS OVER DISTRIBUTED COMPUTING INFRASTRUCTURE

(75) Inventors: Han Chen, White Plains, NY (US); Paul B. Chou, Montvale, NJ (US); Norman H. Cohen, Suffern, NY (US); Sastry S. Duri, Yorktown Heights, NY (US); Yonghun Eom, Seoul (KR); ChangWoo Jung, SeongNam-si (KR); Sooyeon Kim, Seoul (KR); Johnathan M. Reason, Port Chester, NY (US); Danny Chan-Yong Wong, Allendale, NJ (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/876,682

(22) Filed: Oct. 22, 2007

(51) Int. Cl. G06G 7/62

(52) U.S. Cl. 703/17

(57) ABSTRACT

The present invention discloses a method for coordinating zero or more modelings, zero or more implementations and zero or more deployments of a computer system, including but not limited to computer systems involving sensors, actuators, or both and a system providing assistance to designers, implementers, and deployers of computer systems. The method and system including: defining one or more interfaces of one or more components; creating models for the one or more components, each of which is either a composite component model or a atomic component, model, creating the one or more composite components as instances of the composite component models creating the one or more atomic components as instances of the atomic component models creating a domain model by specifying the computational resources; and creating a deployment model by specifying one or more component-model instances and specifying which the component-model instances should be executed on which the computational resources of the domain model.

### BACKGROUND OF THE INVENTION

1. Field of the Invention

The present invention relates to sensor and actuator systems for monitoring and controlling processes generally, and particularly to a system and method of modeling, implementing and deploying computer systems for sensor and actuators.

2. Discussion of the Prior Art

Sensors and actuators have long played a critical role for industry applications. For example, a manufacturing process-control program might use temperature, pressure and acidity sensors to determine the current state of a chemical or metallurgical process, and actuators such as valves, heaters, and coolers to control that process. In another example, an automated assembly line might deploy photo sensors and tactile-pressure sensors to guide robotic actuators to execute manufacturing operations. Such applications are typically self-contained as they are optimized to enable their specific operations.

More recently, with the advent of RFID (Radio Frequency Identification) technologies, individuals and physical assets in a production environment can be identified and tracked in real time for such purposes as enforcing safety and security policies or improving equipment utilization. For example, a retailer in an RFID-enabled supply chain can now provide timely inventory and product-demand data captured at dock doors, back rooms, shelves, and points of sale to upstream suppliers in order to improve the supply-chain efficiency by reducing inventory and avoiding stock-out. While the broad adoption of RFID is still in progress, its potential benefits to business performance have already propelled early adopters to incorporate sensor/actuator applications as an integral part of their business processes. Besides enabling and enhancing individual business operations, sensor/actuator applications provide a bridge between the events and actions in the physical world and business processes.

However, conventional business and industrial operations do not provide an integrated application development and execution environment, which addresses the challenges regarding life-cycle support of applications employing sensors or actuators. Some of the challenges not addressed in the prior art include scalable evolution, flexible determination of distributed topology, and the wide variety of concerns with which the application must deal in various environments. As indicated above, the broad adoption of such technologies as RFID is in progress and as with the introduction of any emerging technology, the adoption of a sensor/actuator application into business processes is typically progressive in terms of scale and complexity of integration. For example, adoption of the technology might start with an isolated, proof-of-concept application prototype and evolve into a full-scale, fully integrated component of the enterprise system. Therefore, an adoption cycle may span from several months to multiple years in which the application is subject to the changes in the technologies and processes involved, in the supporting network and computing capabilities, and in the nature and scale of business operations. Hence, there is a need for integrated application development and execution environment, which addresses the challenges regarding life-cycle support of applications involving sensors or actuators.

Another challenge in providing integrated application development and execution environment is interconnecting sensors and actuators with the Internet, where sensors and actuators act as interfaces between the physical world and cyberspace. Ideally, sensor and actuator placement would involve placement at the locations where physical events occur and actions take place. The geographically distributed nature of sensors and actuators enables a variety of system-topology choices in the prior art. For example, placing information processing or decision making close to the edge of the network results in better responsiveness and reduced dependency on the enterprise infrastructure. In contrast, a centralized approach minimizes the deployment and management costs of remote devices by leveraging pooled resources in data centers managed at the enterprise level. An intermediate approach entails placing computing capabilities in larger facilities, where IT support is available, but using data-center capabilities for smaller operations without on-site IT support. Hence, there is a need for an application to adapt gracefully as an enterprise grows and different choices become appropriate.

Some other challenges in providing integrated application development and execution environment relate to the complexity of the conventional application logic employed in a typical sensor/actuator application. In a typical sensor/actuator application, programmers, developers and implementers have multiple concerns, including: the interactions with the physical environment in which the application operates, the interactions with the business processes that the application supports, the transforming of the sensor observations into business-level events upon which business process can act, and the processing of both physical-process-management and business-level decisions into executable commands to actuators. Developers are faced with a large number of programming models and implementation choices, each of which addresses a particular aspect of the application. Their conundrum is compounded by the potentially diverse, distributed computing platforms on which the application may execute. The lack of a unified programming model and tooling support results in a steep learning curve and integration complexity for sensor/actuator application development. Hence, there is a need for a unified programming model and tooling support for sensor and actuators application development.

Having set forth the limitations of the prior art, it is clear that what is required is a system and method of modeling, implementing and deploying computer systems for sensor and actuators to overcome the above mentioned challenges in the prior art regarding life-cycle support of applications employing sensors or actuators.

### SUMMARY OF THE INVENTION

To that end, the present invention comprises a method of coordinating the modeling, implementing, and deploying of computational resources in a computer systems, including but not limited to computer systems involving sensors, actuators, or both and providing assistance to designers, implementers, and deplorers of computer systems, including but not limited to computer systems involving sensors, actuators, or both.

In one aspect of the invention, a method is provided for coordinating a modeling, an implementation and a deployment of computational resources in a computer system for providing life cycle support, comprising the steps of: (i) defining one or more interfaces of one or more components, the components consuming a streams of events, producing streams of events, or both, wherein each said one or more interfaces includes one or more input ports each having a name and a type, one or more output ports each having a name and a type, and one or more parameters each having a name and a type; (ii) modeling said one or more components as either a composite component model or an atomic component model, each said one or more modeled component conforming to said one or more defined interfaces; (iii) forming instances of one or more composite components and one or more atomic components as instances of said composite component model or atomic component model, respectively; (v) creating a domain model by specifying the computational resources a target execution environment, wherein the domain model is adapted for organizing the computational resources in a hierarchy of one or more named entities; and (vi) creating a deployment model by specifying one or more composite component model instances, one or more atomic component model instances or both and specifying which the one or more composite component model instances and one or more atomic component model instances should be executed on which the computational resources of the domain model.

In yet another aspect of the invention, the step of modeling the one or more components as is either a composite component model or an atomic component model further comprises: modeling the composite component model by specifying one or more component interfaces for one or more subcomponents that is part of a design, and associating one or more event sources that are either input ports of the composite component's interfaces or output ports of a subcomponent interfaces with event destinations that are either input ports of subcomponent interfaces or output ports of the composite component interface, to represent that events emanating from that source should flow to that destination; and modeling the atomic component model by specifying rules for responding to one or more events arriving at the input ports of one or more the defined interfaces.

In still yet another aspect of the invention, the step of creating the one or more composite components as instances of the composite component model or atomic model further comprises: creating one or more composite components as instances of the composite component model by binding the one or more component interfaces specified in one or more composite component models to one ore more actual components, and specifying one or more values as parameters of the one or more interfaces implemented by the composite component model; and creating one or more the one or more atomic components as instances of the atomic component models by defining one or more algorithms for further determine a behaviors of the atomic components, and specifying one or more values for parameters of the one or more interfaces to which the atomic component models conform;

In yet a further aspect of the invention, the step of specifying rules for responding to one ore more events arriving at the input ports of one or more the defined interfaces entails specifying, for disjoint sets of input ports in the interface, the name of a method to be invoked when input events have arrived at all input ports in the set.

In still yet a further aspect of the invention, the step of specifying rules for responding to one ore more events arriving at the input ports of one or more the defined interfaces entails specifying a regular expression with interleaved actions to be matched against an incoming event stream, in which each alphabet symbol in the regular expression matches events arriving at a different input port of the interface and the interleaved actions may include the emitting of events at specified output ports of the interface.

In yet a further aspect of the invention, a composite component model is modeled to conforms to the one or more defined interfaces further includes the step of: specifying a finite-state machine for executing transitions to various states in response to arriving events, and in which the state determines which subcomponents and event-source/event-destination associations are currently active.

In still yet another aspect of the invention, the composite component model further includes: transformations to be applied to all events between a defined event source and the defined event source's associated event destination.

In yet a further aspect of the invention, zero or more of the one or more composite component models or atomic component models represent parts of a graphical user interface (GUI), and one or more composite component models contain one subcomponent for each page of the graphical user interface, and the creating a composite component model that conforms to the one or more defined interfaces further includes the step of specifying a finite-state machine for executing transitions to various states in response to the arriving events, wherein at least one of the subcomponents is determined by the state of the finite-state machine to be active at any time, and the transitions of the finite-state machine correspond to a user's navigation of the graphical user interface among the pages of the graphical user interface.

In another object of the invention, Claim 9, a system is providing for assistance to designers, implementers, and deplorers of for coordinating a modeling, an implementation and a deployment of computational resources in a computer systems, for providing life cycle support, comprising: one or more run-time platforms executing on one or more physical nodes of a distributed system; one or more run-time identifier units for identifying one or more external run-time platforms that are not part of the system: one or more tool units for allowing the designers, implementers, and deplorers of computer systems to perform the following tasks: define, by an instantiation unit, one or more interfaces for one or more components, wherein each the one or more components consuming streams of events, producing streams of events, or both, and each the one or more interfaces includes zero or more input ports each having a name and a type, zero or more output ports each having a name and a type, and zero or more parameters each having a name and a type; model, by a modeling unit, the one or more components as either a composite component model or a atomic component model; form, by a composite and atomic modeling unit, instances of one or more composite components and atomic components as instances of the composite component model or atomic component model, respectively; create, by a domain modeling unit, a domain model of the computational resources in a computer systems; create, by a deployment modeling unit, a deployment model by specifying a composite component model, an atomic component model or both as instances of the domain model to be executed on the one or more run-time platforms, and assigning an IP address and port number to each the one or more run-time platform; and one or more code generators that generate executable program code, in the form of source code in a high-level language, from the composite component or atomic component models.

In yet another aspect of the invention, the modeling unit models the one or more components as either a composite component model or an atomic component model further comprises: modeling the composite component model by specifying one or more component interfaces for one or more subcomponents that is part of a design, and associating one or more event sources that are either input ports of the composite component's interfaces or output ports of a subcomponent interfaces with event destinations that are either input ports of subcomponent interfaces or output ports of the composite component interface, to represent that events emanating from that source should flow to that destination; and modeling the atomic component model by specifying rules for responding to one or more events arriving at the input ports of one or more the defined interfaces.

In still yet a further aspect of the invention, the composite and atomic modeling unit creates the one or more composite components as instances of the composite component model or atomic model further comprises: creating one or more composite components as instances of the composite component model by binding the one or more component interfaces specified in one or more composite component models to one ore more actual components, and specifying one or more values as parameters of the one or more interfaces implemented by the composite component model; and creating one or more the one or more atomic components as instances of the atomic component models by defining one or more algorithms for further determine a behaviors of the atomic components, and specifying one or more values for parameters of the one or more interfaces to which the atomic component models conform.

In yet another further aspect of the invention, the domain modeling unit further comprises: specifying the one or more run-time platforms of a target execution environment, including but not limited to general-purpose computers, special-purpose computers, sensors, and actuators, and specifying one or more component-model instances.

In yet a further aspect of the invention, the one or more code generator generates code from the composite component model to respond to an arrival of events by moving events among a input and an output queues associated with the subcomponents, invoking one or more subcomponents to process events in each the events' respective input queues, and emitting output events from the composite component.

In yet a further aspect of the invention, the code generated by the code generator also applies transformations to events as they are moved between the queues.

In yet a further aspect of the invention, the code generated by the code generator also updates the state of a finite-state machine associated with the composite-component model in response to events arriving at the composite component, and activates and deactivates subcomponents and connections based on the state of the finite state machine.

In yet a further aspect of the invention, the modeling of atomic components with rules specifying responses to events arriving at the input ports of the interface specifying, for disjoint sets of input ports in the interface, the name of a method to be invoked when input events have arrived at all input ports in the set.

In yet a further aspect of the invention, the code generator generates skeletal source code for the modeled component, with an empty method body for each method named in the model.

In yet a further aspect of the invention, the modeling atomic components with rules specifying responses to events arriving at the input ports of the interface entails specifying a regular expression with interleaved actions to be matched against an incoming event stream, in which each alphabet symbol in the regular expression matches events arriving at a different input port of the interface and the interleaved actions may include the emitting of events at specified output ports of the interface.

In yet a further aspect of the invention, the code generator generates a transition table for a finite-state machine recognizing the regular expression, each entry in the transition table specifying the action to be performed and a new state upon the arrival of an event matching a particular alphabet symbol of the regular expression while the finite-state machine is in a specified old state.

In yet a further aspect of the invention, the code generator generates a representation of a stateful data structure with an operation for processing an input event as specified by the regular expression.

In yet a further aspect of the invention, the model of a composite component includes the specification of a state machine that executes transitions to various states in response to arriving events.

In yet a further aspect of the invention, the tool units includes an integrated development environment (IDE).

In yet a further aspect of the invention, the tool units includes one or more domain controllers to administer the run-time platforms.

In yet a further aspect of the invention, the tool units includes one or more library servers in which the one ore more components are stored.

In yet a further aspect of the invention, the tool units includes a palette from which icons representing component interfaces can be dragged and dropped onto the canvas of a graphical editor being used to construct a composite component model, to specify that the subcomponent interfaces of the composite component model include those represented by the dragged and dropped icons

### BRIEF DESCRIPTION OF THE DRAWING FIGURES

The foregoing and other objects, aspects and advantages will be better understood from the following detailed description of embodiments of the inventions, with reference to the drawings, in which:

FIG. 1 illustrates an integrated embedded device solution according to the present invention;

FIG. 2 illustrates a system consisting of an integrated development environment (IDE), run-time platforms, domain controllers, and library servers according to the present invention;

FIG. 3 illustrates the components the IDE depicted in FIG. 2 in according to the present invention;

FIG. 4 illustrates an IDE implemented as a set of plug-ins installed in an Eclipse platform in according to the present invention;

FIG. 5 illustrates a graphical editor editing an exemplary model of an atomic component according to the present invention;

FIG. 6 illustrates an exemplary regular expression with embedded computational actions modeling an atomic component according to the present invention;

FIG. 7 illustrates a graphical editor editing an exemplary model of a composite component according to the present invention;

FIG. 8 illustrates modeling the structural and behavioral characteristics of a composite component of a graphical user interface (GUI) according to the present invention;

FIG. 9 illustrates a graphical editor canvas that includes icons representing named interfaces of a modeled component and a graphical representation of the component implementation; and

FIG. 10 illustrates a production run-time platform executing on one or more physical nodes of a distributed system.

### DETAILED DESCRIPTION OF THE INVENTION

The present invention has two aspects. The first aspect is a method of modeling, implementing, and deploying computer systems, including but not limited to computer systems involving sensors, actuators, or both. The second aspect is a system providing assistance to designers, implementers, and deplorers of computer systems, including but not limited to computer systems involving sensors, actuators, or both.

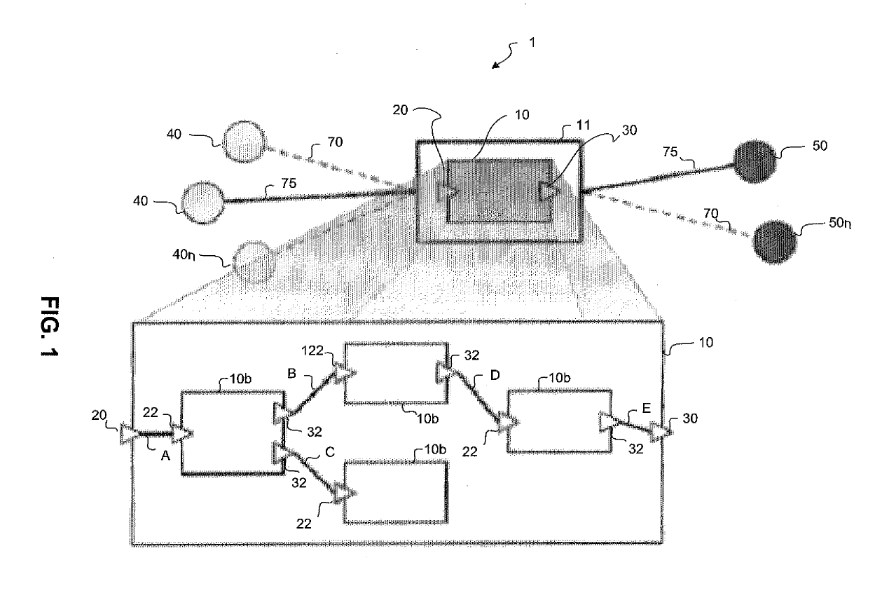

Sensors and actuators can be leveraged and used to trigger the business processes and scenarios as described in the background of invention section, where in order to carry out functions desired by users, sensors and actuator devices are coordinated. For example as can be seen in FIG. 1, an integrated embedded device solution 1 accomplishes this by connecting sensors 40/40n and actuators 50/50n devices to a controller node 11 and a composite component 10 via wireless links 70 or wired links 75 and input port 20 and output port 30. Within the controller node 11, the composite component 10 executes certain application logic as an “embedded device solution.” More specifically, an embedded device solution can be created, deployed and managed by defining as the composite component 10 to contain n-number of components 10b with input ports 22 and output ports 32 linked together by connections A-E. This modeling provides a graphical block diagram methodology for actor-oriented modeling as described in Reason, Jonathan M. et al. “A Framework for Managing the Solution Life Cycle of Event-Driven Pervasive Applications,” IFIP International Conference on Embedded and Ubiquitous Computing, August 2006 see Also. Jung ChangWoo, et al “Embedded Device Solution Life Cycle Support with Eclipse” Proceedings of the 2006 OOPSLA workshop on eclipse technology eXchange, Oct. 22-23, 2006.

As can be seen in FIG. 1, an embedded device solution 1 supports the construction of an event-based application from components 10b. Components 10b encapsulate application logic and are the minimum units of code for development, publishing, reuse, and deployment. Each component 10b has one or more input ports 20 through which it consumes events, one or more output ports 30 through which it emits events, and executable logic that governs the manner in which the component 10 responds to incoming events and emits outgoing events. An event is a message, typically containing data. A sensor, or the software interface to a sensor, can be realized in this system as a component with one or more output ports, but no input ports; the events emitted through these output ports are data gathered by the sensor. An actuator, or the software interface to an actuator, can be realized in this system as a component with one or more input ports, but no output ports; the events received through these input ports are commands governing the actuator.

In addition to the accompanying drawings the following description and definitions will further clarify the present invention. In the present invention a component has one or more parameters. A parameter is a named placeholder for a value that may be used to customize the behavior of the component. There is a data type associated with each port; the data contained in the events received by an input port or emitted by an output port must belong to that data type. In addition, each parameter of a component is declared to belong to a particular data type. In the preferred embodiment, a data type may be a primitive type—boolean, double, long, object, string, or time—an array type with elements of a specified type, or a structure type with named fields of specified types. The primitive type boolean consists of the values true and false. The primitive type double consists of 64-bit IEEE-754 floating-point values. The primitive type long consists of 64-bit signed integer values. The primitive type object represents an opaque object reference that a component may receive in input events or send in output events, but whose contents may not be examined or manipulated. The primitive type string consists of sequences of Unicode characters. The primitive type time consists of time stamps each comprising a date and a time of day. For each value in one of these data types, there is a corresponding representation as a Java object, and there are Java methods to construct such Java objects and to analyze the contents of such Java objects. It will be appreciated that the present invention anticipates other type-systems as well, including the trivial type system in which there is a single data type to which all messages and parameters belong. The present invention also anticipates an embodiment in which there are distinct type systems for the data in event messages and for component parameters.

In the present invention an interface is an abstracted view of a component, describing certain characteristics of that component. An interface applicable to a component consists of the names and types of one or more of the component's input ports, the names and types of one or more of the component's output ports, and the names and types of one or more of the component's parameters. Many interfaces may be applicable to a given component, and a given interface may be applicable to many components.

The system uses application-oriented models as the basis of both the construction and the deployment of event-based applications. Component models specify the components of the application and the interconnections among them. Domain models specify the computational resources of the deployment site, possibly including sensors, actuators, general-purpose processors, and special-purpose processors, organized into hierarchical modules. A deployment model specifies which components are to execute on which computational resources. The system processes these models to create components in a form suitable for execution on the corresponding resources.

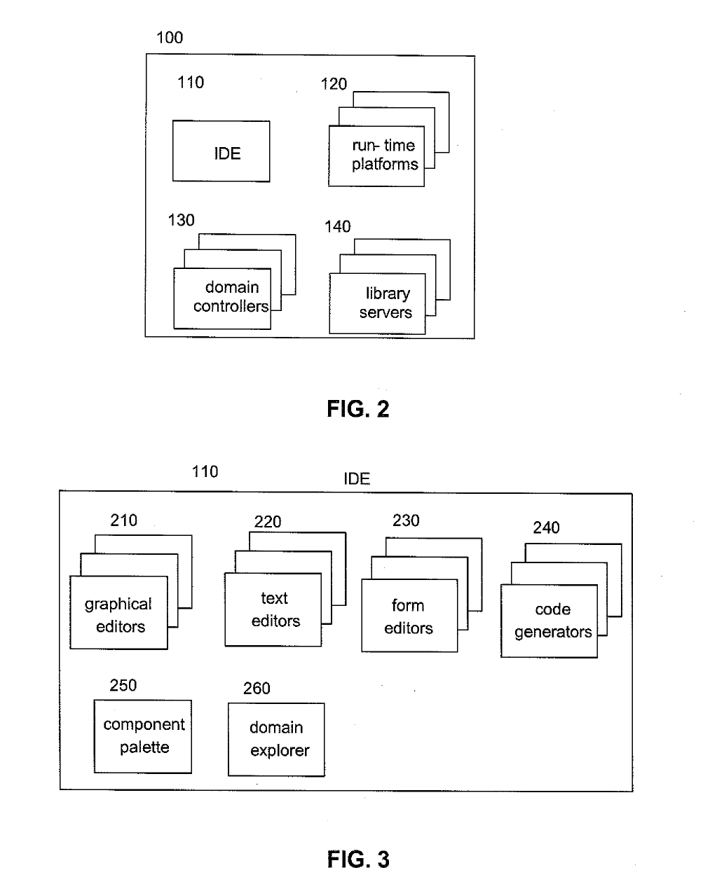

As shown in FIG. 2, in a preferred embodiment, the system 100 consists of an integrated development environment (IDE) 110, one or more run-time platforms 120, one or more domain controllers 130, and one or more library servers 140. The IDE 110 allows developers to model, implement, assemble, test, and deploy applications following a component-based approach. The run-time platforms 120 include one or more local run-time platforms used by application developers for testing and one or more production run-time platforms, possibly running on distributed computing nodes, in the target execution environment. Domain controllers 130 include a local domain controller used to manage the local run-time platforms and a production domain controller used to manage the run-time platforms of the production environment. Library servers 140 provide code repositories for components to be stored, browsed, and retrieved by the IDE 110 and the run-time platforms 120.

As shown in FIG. 3, the components of the IDE 110 may include one or more graphical editors 210, one or more text editors 220, one or more form editors 230, one or more code generators 240, a component palette 250, and a domain explorer 260.

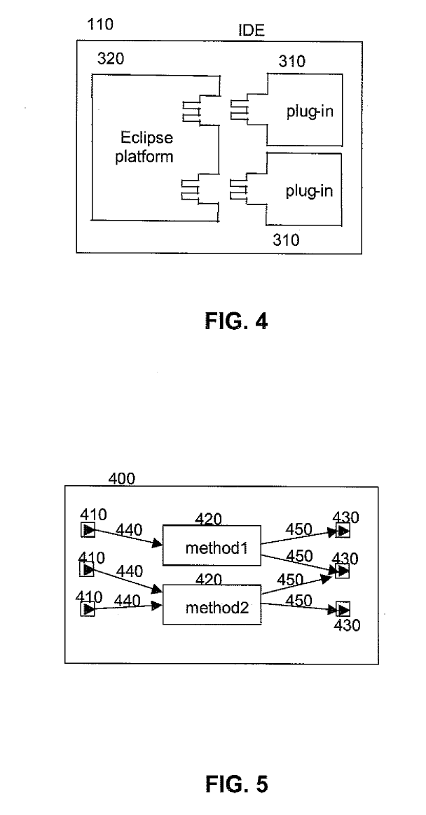

In the preferred embodiment, the IDE 110 is implemented as a set of plug-ins 310 installed in an Eclipse platform 320, as shown in FIG. 4, and some of the editors create XMI representations of the artifacts they edit, based on meta-models defined in the Eclipse Modeling Framework; however, it will be appreciated that other implementations are also possible as known to those skilled in the art. Eclipse is a development platform comprising extensible frameworks, tools and runtimes for building, deploying and managing software across the lifecycle, available as open software at http://www.eclipse.org/.

Referring back to FIG. 3, the component palette 250 contains icons representing components stored in a library server 140, possibly organized into a hierarchy of folders. Various implementations of library servers may be plugged into the component palette. For example, the OSGI Alliance (http://www.osgi.org/) has defined a dynamically extensible Java framework for delivering and managing dynamically downloadable services, packaged in components called bundles, into networked environments. The Oscar Bundle Repository (OBR) is a repository for OSGi bundles (described at http://oscar-osgi.sourceforge.net/). In the preferred embodiment, there is a default library-server implementation based on OBR.

A component, in the present invention, may be modeled either as an atomic component or a composite component. Models for atomic components include, but are not limited to, a set of rules for the invocations of methods or a regular expression with embedded computational actions. A model for a composite component includes a set of component references, a finite-state machine, and a specification, for each state of the finite-state machine, of which referenced components are active, which input ports of the composite component provide events to which input ports of referenced components, which output ports of referenced components provide events to which input ports of referenced components, and which output ports of referenced components provide events to which output ports of the composite component.

For an atomic component modeled by a set of rules for the invocations of methods, a model may be created by a graphical editor 210. The graphical editor may be used to draw a diagram such as the diagram 400 depicted in FIG. 5, which includes icons 410 representing input ports, icons 420 representing methods to be invoked, icons 430 representing output ports, input arrows 440 leading from input-port icons 410 to method icons 420, and output arrows 450 leading from method icons 420 to output-port icons 430, with the restriction that there be no more than one input arrow 440 emanating from any one input-port icon 410. Such a model specifies that, for each method icon 420, when input events have arrived at each input port with an input-port icon 410 connected by an input arrow 440 to that method icon, the method named by that icon should be invoked, with the value of the earliest event to have arrived at each of those ports consumed and passed to the invoked method as a parameter, and that for each output port for which an output arrow 450 connects the method icon 420 to the corresponding output-port icon 430, an object representing that output port should also be passed to the invoked method as a parameter. The system provides a means by which the invoked method can generate output events and dispatch them to output ports represented by particular method parameters. The atomic component emits these events from the output ports to which they have been dispatched upon completion of the invoked method.

Referring back to FIG. 3, then the diagram created in the graphical editor 210 is saved, a code generator 240 generates program text implementing the method-invocation rules. The generated program text includes empty bodies for the methods to be invoked. The application developer can use a text editor 220 to add application logic to these method bodies. In the preferred embodiment, the generated program text is a Java class, but the present invention also anticipates program text generated in other programming languages. In some programming languages, the role played a method in Java is played by an entity called, for example, a function, procedure, or subroutine, or subprogram. In addition to the generated program text implementing the method-invocation rules, the code generator 240 generates program text that tracks the arrival of input events and manages the emission of output events.

For an atomic component modeled by a regular expression with embedded computational actions, such as the regular expression with embedded computational actions 500 depicted in FIG. 5, a model may be created by a text editor 220. The model associates an event name with each input port and matches the regular expression against the sequence of event names corresponding to the sequence of event arrivals at input ports. A regular expression is a pattern that can be matched against a sequence of symbols. The possible forms of a regular expression include a placeholder that matches a particular symbol; a sequence of some number n of smaller regular expressions that matches any string of symbols consisting of n consecutive substrings, each of which matches the corresponding smaller regular expression in the sequence; a union of smaller regular expressions that matches any string of symbols matched by any one of the smaller regular expressions; and a repetition of a smaller regular expression that matches any string of symbols consisting of zero or more consecutive substrings, each matched by the smaller regular expression. In some formulations, there are additional forms of regular expressions, such as the phi regular expression that does not match any string of symbols; the epsilon regular expression that matches only the empty string; a wildcard that matches any one symbol; an intersection of smaller regular expressions that matches any string of symbols matched by all of the smaller regular expressions; a difference of two smaller regular expressions that matches any string of symbols matched by the first smaller regular expression and not matched by the second smaller regular expression; and an extended repetition of a smaller regular expression that places a lower bound, or both a lower bound and an upper bound, on the number of consecutive substrings, each matched by the smaller regular expression, that can occur in a string of symbols it matches The notion of a regular expression is well known in the field of computer science. Many programming languages—such as awk, C#, Java, JavaScript Perl, PHP, Python, Ruby, and Visual Basic—and programming tools—such as grep, sed, and vi—include regular expressions matching character strings, in which the symbols are characters and a placeholder or wildcard matches a single character. In the present invention, an atomic component may be modeled by a regular expression matching a stream of incoming events; this stream is viewed as a string of symbols, each of which has an event name, and each placeholder in the regular expression matches a symbol with a particular event name. Sequences of this regular expression are extended to include not only smaller regular expressions, but also embedded computational actions, executed when the corresponding point in the sequence are encountered in the matching process. These actions may include the emitting of named output events at output ports associated with the output-event names.

When the regular expression created in the text editor 220 is saved, a code generator 240 generates a state-transition table for a finite-state transducer corresponding to the regular expression. Each run-time platform 120 includes an engine that interprets such tables, handling arriving input events and emitted output events. In the preferred embodiment, the regular expression with embedded computational actions 500 is written in the EventScript language.

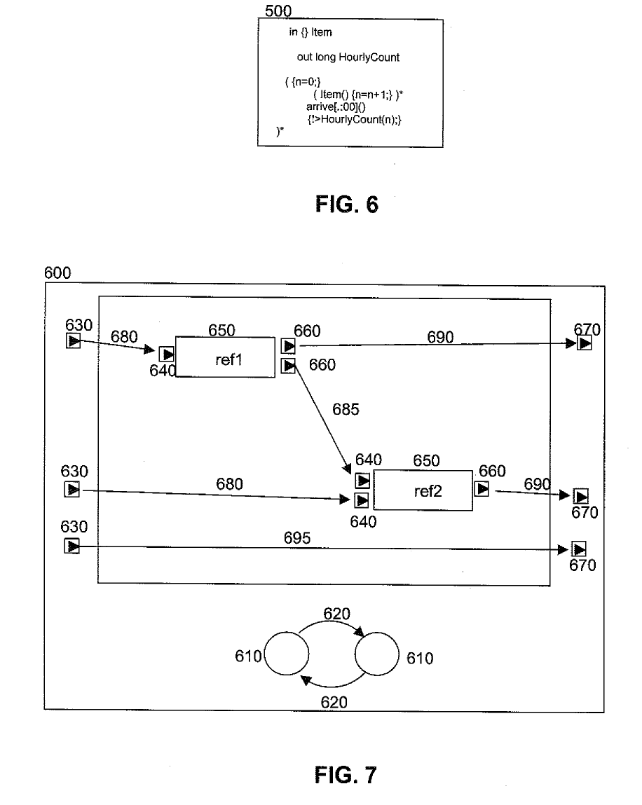

For a composite component, a model may be created by a graphical editor 210. The graphical editor may be used to draw a diagram such as the diagram 600 depicted in FIG. 6, which may include circles 610 representing states of a finite-state machine, state-transition arrows 620, icons 630 representing input ports of the composite component, icons 640 representing input ports of component references, icons 650 representing component references, icons 660 representing output ports of component references, icons 670 representing output ports of the composite component, input arrows 680 leading from composite-component input-port icons 630 to component-reference input-port icons 640, internal arrows 685 leading from component-reference output-port icons 660 to component-reference input-port icons 640, output arrows 690 leading from component-reference output icons 660 to composite-component output-port icons 670, and pass-through arrows 695 leading from composite-component input-port icons 630 to composite-component output-port icons 670. A form editor 230 may be used to associate a transformation on event data with an arrow 680, 685, 690, or 695. The event transformation is specified as a Java expression for the Java-object representation of a value whose data type is the data type associated with the port icon 630 or 660 at the head of the arrow. This expression contains a placeholder representing the Java-object representation of a value whose data type is the data type associated with the port icon 640 or 670 at the tail of the arrow. If no such transformation is specified for an arrow 680, 685, 690, or 695, the arrow connects a port icon 630 or 660 representing a port associated with a particular data type to a port icon 640 or 670 representing a port associated with the same data type.

In the present invention a component reference is a placeholder for a component with a particular interface, which may later be bound to a particular component to which that interface is applicable. In the preferred embodiment, component-reference icons can be created in the graphical editor 210 by dragging icons representing components from the component palette 250 and dropping them onto the editor's drawing canvas. The circles 610 and state-transition arrows 620 specify a finite-state machine. A form editor 230 may be used to associate an input port of the composite component, an optional condition, and an optional action with each state-transition arrow 620. The graphical editor may be used to identify a particular state of the finite-state machine as the initial state. The graphical editor may be used to indicate which component-reference icons 650 and which arrows 680, 685, 690, and 695 are active in a given state of the finite-state machine. The present invention anticipates other ways of specifying the information in the model of a composite component, besides the use of a graphical editor 210 and a form editor 230 to play the particular roles that these editors play in the preferred embodiment.

The model specifies the following behavior: If the state machine is currently in the state corresponding to the circle 610 at the tail of some state-transition arrow 620, an event arrives at the composite-component input port associated with that arrow, and the condition associated with that arrow either is absent or evaluates to true, then the state machine performs the action, if any, associated with the arrow and transits to the state corresponding to the circle 610 at the head of the state-transition arrow. If no circles 610 or state-transition arrows 620 are present in the diagram 600, the effect is as if the state machine for the composite component has a single state, and all component-reference icons 650 and arrows 680, 685, 690, and 695 are active in that state. When an event arrives at a composite-component input port, any applicable state transition is performed. Then, for every input arrow 680 active in the current state leading from the corresponding composite-component input-port icon 630 to some input-port icon 640 of a component-reference icon 650 active in the current state, a possibly transformed version of the event is placed on the corresponding input port of the component to which the component reference is bound, and for every pass-through arrow 695 active in the current state leading to some composite-component output-port icon 670, a possibly transformed version of the event is emitted through the corresponding output port of the composite component. Each component bound to a component reference whose icon 650 is active in the current state then processes the events that have been placed in its input ports, according to the models for those components. If such a component should emit an output event on one of its output ports, then, if there is an internal arrow 685, active in the current state, leading from the corresponding component-binding output-port icon 660 to the component-binding input-port icon 640 of some other component-binding icon 650 active in the current state, a possibly transformed version of the event is placed on the corresponding input port of the component to which the component reference is bound; otherwise, if there is an output arrow 690, active in the current state, leading from the corresponding component-binding output-port icon 660 to a composite-binding output-port icon 670, a possibly transformed version of the event is emitted through the corresponding output port of the composite component.

The placing at a port corresponding to the port icon at the head of an arrow 680, 685, 690, or 695 of a possibly transformed version of an event provided by the port corresponding to the port icon at the tail of the arrow proceeds as follows: If there is no transformation associated with the arrow, the event itself is placed at the port corresponding to the port icon at the head of the arrow. Otherwise, the Java expression of the event transformation is evaluated, with the placeholder in that expression evaluating to the Java-object representation of the event value, and a new event, containing the value whose Java-object representation is given by the result of the expression evaluation, is placed at the port corresponding to the port icon at the head of the arrow.

When the composite-component model created in the graphical editor 210 is saved, a code generator 240 generates program text that tracks the arrival of input events to the composite component, tracks the current state of the composite component's state machine, manages the transport of events to the components to which component references are bound, schedules the invocation of those components, and manages the emission of output events by the composite component.

As illustrated in FIG. 7, a composite component can model the structure and behavior of a graphical user interface (GUI), and code implementing the GUI can be generated automatically from the model. The composite component 710 modeling the GUI contains several subcomponents 720 each corresponding to a page (or screen) of the GUI. Each page subcomponent 720 contains widget subcomponents 725 corresponding to the GUI widgets (text fields, buttons, sliders, progress bars, etc.) appearing on that page. The finite-state machine 730 of the composite component 710 has a state 731 corresponding to each page of the GUI; when the finite-state machine 730 is in the state 731 corresponding to a given page, the page subcomponent 720 corresponding to that page is active, and the other page subcomponents 720 are inactive. A GUI engine 740 exchanges data with a rendering engine 770 on a client platform 750 to cause widgets 765 corresponding to the widget subcomponents 725 of the active page subcomponent 720 to appear on the drawing canvas 760 of the client platform. Possible implementations of the client rendering engine 770 include, for example, a web browser (in which case the information provided by the GUI engine 740 includes HTML, possibly with embedded JavaScript in the AJAX style), an Eclipse Rich Client Platform (in which case the information provided by the GUI engine 740 might include some representation of calls on methods of the Standard Widget Toolkit, or SWT, to be executed on the client platform 750), or a Java Virtual Machine, or JVM (in which case the information provided by the GUI engine 740 might include some representation of calls on methods of the Abstract Window Toolkit, or AWT, to be executed on the client platform 750). The writer of the composite component modeling the GUI need not be concerned with the implementation of the GUI engine 740 and the client rendering engine 770.

When an end user of the client platform 750 performs some action on a widget 765, thus generating a GUI event, the client rendering engine 770 captures this event and transmits a message describing the event to the GUI engine 740. The GUI engine 740 responds to the receipt of this message by generating an input event for the currently active page subcomponent 720, and that page subcomponent 720 passes that event on to the widget subcomponent 725 corresponding to the widget 765 on which the action was performed. The arriving event may also cause the finite-state machine 730 to execute a transition 732 to a new state 731, thus causing a new page to become active. Thus the transitions 732 of the finite-state machine 730 correspond to ways that an end user may navigate from one page of the GUI to another.

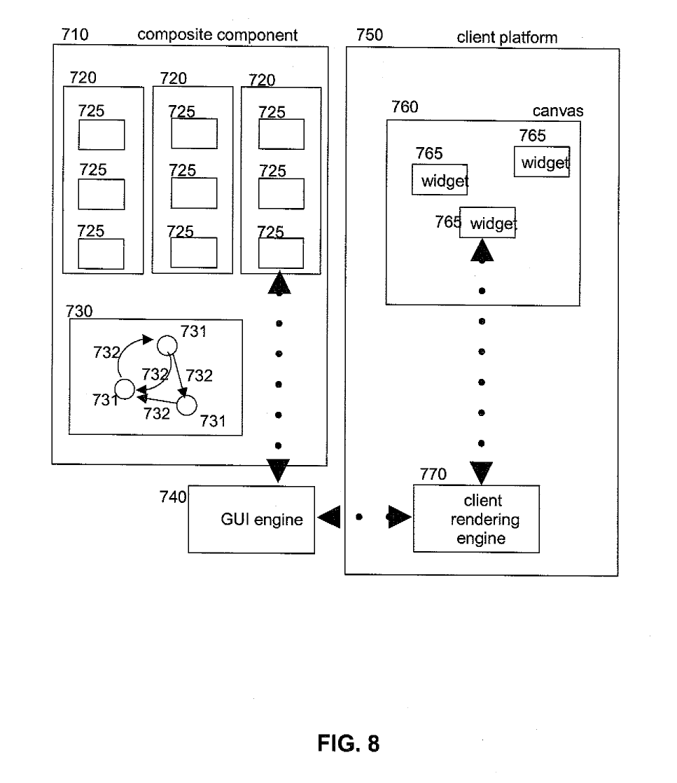

Whether it is being used to edit a model for an atomic component consisting of method-invocation rules or a model for a composite component, the graphical editor 210 presents a canvas 800 that, as illustrated in FIG. 8, includes icons 810 representing named interfaces of the modeled component and a graphical representation 820 of the component implementation The graphical representation 820 of the component implementation may be a depiction 400 of method-invocation rules or a depiction 600 of the states, component references, and data flows of a composite component. An application developer can select a particular interface using the graphical editor, in which case only those input and output ports of the component named in the interface appear in the graphical representation 820 of the component implementation.

The binding of a component reference to a component can be specified as part of the component model at development time, as part of the deployment model at deployment time, or through the administrative console of a domain controller 130 at execution time. A component reference must be bound to a component before a composite component containing the reference it can be invoked. The binding is specified as a URI. The URI specifies a run-time platform and either the name of a component implementation to be instantiated on that run-time platform or the name of a component instance already executing on that run-time platform.

A domain model enumerates the run-time platforms 120 of the execution environment and the components that make up the application.

A deployment model refers to component instances and run-time platforms 120 in the domain model, and specifies which component instances will execute in which run-time platforms. It also relates the run-time platforms of the domain model to the physical infrastructure of the production execution environment by assigning an IP address and port number to each run-time platform. By default, a subcomponent of a composite component executes in the same run-time platform as the composite component, but the deployment model can override this default by explicitly specifying a different run-time platform for the subcomponent. A deployment model may be created or edited, typically by a system integrator, using a form editor 230 of the IDE 110. An XML representation of the deployment model can then be imported into the production domain controller 130 through its administrative console. Alternatively, a deployment model may be modified, typically by a system administrator, using the administrative console of the domain controller as known to those skilled in the art.

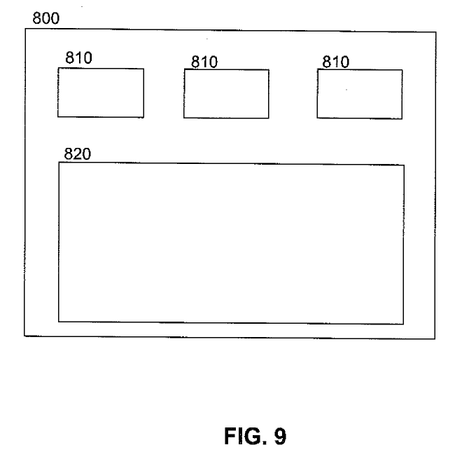

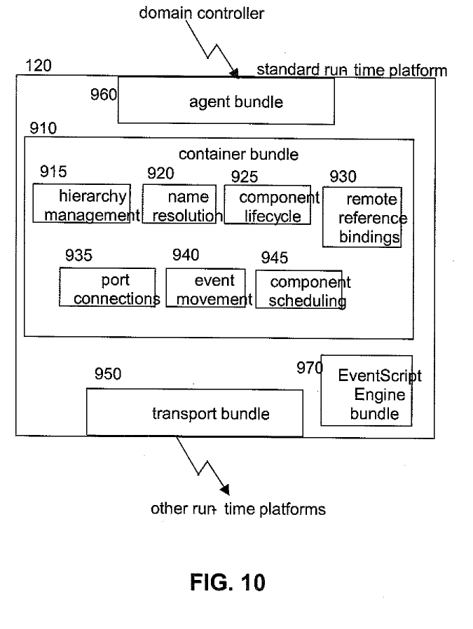

Production application of a deployment model results in a production environment with one or more production run-time platforms 120, executing on one or more physical nodes of a distributed system. In the preferred embodiment, there is a standard implementation of the run-time platform, called the standard run-time container. This run-time platform is based on Equinox, an Eclipse implementation of the Open Service Gateway initiative (OSGi) R4 specification incorporated by reference herein. Both the code for the run-time platform itself and the code for application components running on the run-time platform are packaged in OSGi bundles. As illustrated in FIG. 9, the code for the standard run-time platform itself includes a container bundle 910, a transport bundle 950, an agent bundle 960, and an EventScript Engine bundle 970. The container bundle provides a number of functions necessary for the execution of the application logic in composite components and method-invocation-based atomic components. These functions include management 915 of the hierarchy of nested composite components; resolution 920 of interface, component, and port names; management 925 of the component lifecycle, including loading, instantiation, activation, deactivation, and destruction; management 930 of component references to components in other run-time platforms; management 935 of connections among the ports of a composite component; management 940 of event movement within a composite component; and scheduling 945 of the processing of input ports by components. The transport bundle 950 implements an OSGi service to provide for communication of event data between this run-time platform and other run-time platforms. Bundles for various means of communication, such as MQtt/MicroBroker or TCP/UDP, can be plugged in to provide this service. The preferred embodiment includes an MQtt/MicroBroker bundle. The agent bundle 960 controls the run-time platform on behalf of the domain controller 130. It receives and requests from the domain controller and invokes the actions that fulfill those requests. Each run-time platform is uniquely identified by the IP address of its physical node and the number of the port at which its agent listens for requests from the domain controller. The EventScript Engine bundle 970 interprets state-transition tables for atomic components modeled by a regular expression with embedded computational actions.

The current invention also anticipates an embodiment in which there one or more run-time platforms other than instances of the standard runtime container, possibly implemented as instances of independently developed middleware. Different run-time platforms may have different programming interfaces. In this embodiment, the IDE 110 includes different code generators 240 for different run-time-platform interfaces. The domain model specifies the interface implemented by each run-time platform in the model, and the IDE uses the domain model and the deployment model to determine which code generator to invoke for each model component.

The set of production run-time platforms is managed by a production domain controller 130. The domain controller is a centralized J2EE application that manages all run-time platforms within a domain. In the preferred embodiment, the domain controller provides the system administrator with a view of the system as a single virtualized container. The virtualized container allows the system administrator to manage the production environment through the domain-controller console as if all components were running on a single run-time platform. An administrator can use the administrative console of the domain controller to add or remove an actual run-time platform, install or uninstall a component instance, modify the bindings of a component instance, change the parameters of a component instance, start or stop a component instance, or monitor events flowing into or out of a component instance. The virtualized container determines which communications facilities are invoked for each port of each component, based on whether the ports are connected to a component running in the same actual production run-time platform, to a component running in a different actual production run-time platform, or both. Different transport bundles can be plugged into run-time platforms to provide different means, such as MQtt/MicroBroker or TCP/UDP, for communication between components in different run-time platforms.

The system may include a test environment accessible from the computer running the IDE 110. This test environment consists of one or more run-time platforms 120, a local domain controller 130, and a library server 140 accessible from the computer running the IDE. The IDE includes a domain explorer 250 that acts as the administrative console for the local domain controller. Executable components generated by the IDE may be stored in this library server. A deployment model stored in the IDE can be applied in the test environment. This results in the creation of a local run-time platform for each run-time platform specified in the deployment model. The test environment may also contain a unit-testing facility that feeds streams of events specified in an input-trace file to input ports of a component being tested in isolation, and compares the events emitted by that component to the expected output in an output-trace file. The input-trace file may include time stamps specifying the simulated time at which particular events are to occur.

The present invention can also be embodied as a program on a computer-readable recording medium. Examples of the computer-readable recording medium include but are not limited to Compact Disc Read-Only Memory (CD-ROM), Random-Access Memory (RAM), floppy disks, hard disks, and magneto-optical disks.

While there has been shown and described what is considered to be preferred embodiments of the invention, it will, of course, be understood that various modifications and changes in form or detail could readily be made without departing from the spirit of the invention. It is therefore intended that the scope of the invention not be limited to the exact forms described and illustrated, but should be construed to cover all modifications that may fall within the scope of the appended claims.

What is claimed is:

1. A method for coordinating zero or more modelings, zero or more implementations and zero or more deployments of a computer system including one or more computational resources, comprising the steps of:
(i) defining one or more interfaces of one or more components, said components consuming a streams of events, producing streams of events, or both, wherein each said one or more interfaces includes one or more input ports each having a name and a type, one or more output ports each having a name and a type, and one or more parameters each having a name and a type;
(ii) modeling said one or more components as either a composite component model or an atomic component model, each said one or more modeled components conforming to said one or more defined interfaces;
(iii) forming instances of one or more composite components and one or more atomic components as instances of said composite component model or atomic component model, respectively;
(iv) creating a domain model by specifying one or more of said computational resources in a target execution environment; and
(v) creating a deployment model by specifying one or more composite component model instances, one or more atomic component model instances, or both, and specifying on which said computational resources of the domain model which said one or more composite component model instances and one or more atomic component model instances are to be executed.

2. The method as in claim 1, wherein said steps of modeling said one or more components as either a composite component model or an atomic component model and forming said one or more composite components as instances of said composite component model or atomic model further comprises, further comprises:
modeling said one of said one or more components as said composite component model by specifying one or more component interfaces for one or more subcomponents that is part of a design, and associating one or more event sources that are either input ports of the composite component's interfaces or output ports of a subcomponent interfaces with event destinations that are either input ports of subcomponent interfaces or output ports of the composite component interface, to represent that events emanating from that source should flow to that destination; and
creating one or more said one or more atomic components as instances of said atomic component models by defining one or more algorithms to further determine a behaviors of said atomic components, and specifying one or more values for parameters of said one or more interfaces to which said atomic component models conform;

3. The method as in claim 1, wherein said steps of modeling said one or more components as either a composite component model or an atomic component model and forming said one or more composite components as instances of said composite component model or atomic model further comprises:
modeling said one of said one or more components as said atomic component model by specifying rules for responding to one or more events arriving at said input ports of one or more said defined interfaces; and
creating one or more composite components as instances of said composite component model by binding said one or more component interfaces specified in one or more composite component models to one or more actual components, and specifying one or more values as parameters of said one or more interfaces implemented by said composite component model;

4. The method as in claim 1, further comprising:
specifying rules for responding to one or more events arriving at said input ports of one or more said defined interfaces and including, specifying, for disjoint sets of input ports in the interface, a name of a method to be invoked when input events have arrived at all input ports in the disjoint set.

5. The method as in claim 1, further comprising:
specifying rules for responding to one or more events arriving at said input ports of one or more said defined interfaces and including, specifying a regular expression with interleaved actions to be matched against an incoming event stream, in which an alphabet symbol provided in the regular expression matches events arriving at a different input port of the interface and the interleaved actions may include the emitting of events at specified output ports of the interface.

6. The method as in claim 2, wherein said modeling a composite component model that conforms to said one or more defined interfaces further includes the step of:
specifying a finite-state machine for executing transitions to various states in response to arriving events, and determining from an executing state, which the state determines which subcomponents and event-source/event-destination associations are currently active.

7. The method as in claim 2, wherein said composite component model further includes:
applying transformations to all events between a defined event source and said defined event source's associated event destination.

8. The method as in claim 2, wherein zero or more of said one or more composite component models or atomic component models represent parts of a graphical user interface (GUI), and one or more composite component models contain one subcomponent for each page of said graphical user interface, and said creating a composite component model that conforms to said one or more defined interfaces further includes the step of:
specifying a finite-state machine for executing transitions to various states in response to said arriving events, wherein exactly one of the subcomponents is determined by said state of the finite-state machine to be active at any time, and said transitions of the finite-state machine correspond to a user's navigation of said graphical user interface among the pages of the graphical user interface.

9. A system for providing assistance to designers, implementers, and deployers for coordinating zero or more modelings, zero or more implementations and zero or more deployments of a computer system, comprising:
one or more run-time platforms executing on one or more physical nodes of a distributed computing system;
one or more resource identifier units for identifying one or more external run-time platforms that are not part of said system:
one or more tool units for enabling said designers, implementers, and deployers of computer systems to perform one or more of the following tasks:
defining, by an interface definition unit, one or more interfaces for one or more components, wherein each said one or more components consuming streams of events, producing streams of events, or both, and each said one or more interfaces includes zero or more input ports each having a name and a type, zero or more output ports each having a name and a type, and zero or more parameters each having a name and a type;
modeling, by a modeling unit, said one or more components as either a composite component model or a atomic component model;
forming, by a instantiation unit, instances of one or more composite components and atomic components as instances of said composite component model or atomic component model, respectively;
creating, by a domain modeling unit, a domain model of one or more computational resources in a computer systems;
creating, by a deployment modeling unit, a deployment model by specifying which said instance of said composite component model, said atomic component model or both of said domain model be executed on said one or more run-time platforms, and assigning an IP address and port number to each said one or more run-time platform; and
one or more code generators that generate a first executable program code that can be complied into a second executable code, from said composite component or atomic component models.

10. The system as in claim 9, wherein said modeling unit models said one or more components as either a composite component model or an atomic component model further comprises:
modeling said composite component model by specifying one or more component interfaces for one or more subcomponents that are part of a design, and associating one or more event sources that are either input ports of the composite component's interfaces or output ports of a subcomponent interfaces with event destinations that are either input ports of subcomponent interfaces or output ports of the composite component interface, to represent that events emanating from that source should flow to that destination; and
modeling said atomic component model by specifying rules for responding to one or more events arriving at said input ports of one or more said defined interfaces.

11. The system as in claim 9, wherein said composite and atomic modeling unit creates said one or more composite components as instances of said composite component model or atomic model further comprises:
creating one or more composite components as instances of said composite component model by binding said one or more component interfaces specified in one or more composite component models to one or more actual components, and specifying one or more values as parameters of said one or more interfaces implemented by said composite component model; and
creating one or more said one or more atomic components as instances of said atomic component models by defining one or more algorithms for further determining behaviors of said atomic components, and specifying one or more values for parameters of said one or more interfaces to which said atomic component models conform.

12. The system as in claim 9, wherein said domain modeling unit further comprises:
specifying said one or more run-time platforms of a target execution environment, including as one or more of: general-purpose computers, special-purpose computers, sensors, and actuators, and specifying one or more component-model instances.

13. The system as in claim 9, wherein said one or more code generators generates code from said composite component model to respond to an arrival of events by moving events among input and output queues associated with said subcomponents, invoking one or more subcomponents to process events in each said events' respective input queues, and emitting output events from said composite component.

14. The system as in claim 13, wherein said code generated by the code generator also applies transformations to events as they are moved between said queues.

15. The system as in claim 13, wherein said code generated by said code generator also updates the state of a finite-state machine associated with said composite-component model in response to events arriving at said composite component, and activates and deactivates subcomponents and connections based on the state of the finite state machine.

16. The system as in claim 11, wherein said modeling atomic components includes one or more rules specifying responses to events arriving at the input ports of the interface and specifying, for disjoint sets of input ports in the interface, a name of a method to be invoked when input events have arrived at all input ports in the disjoint set.

17. The system as in claim 17, wherein said code generator generates skeletal source code for the modeled component, with an empty method body for each method named in the model.

18. The system as in claim 11, wherein said modeling atomic components includes one or more rules specifying responses to events arriving at the input ports of the interface and specifying a regular expression with interleaved actions to be matched against an incoming event stream, in which each alphabet symbol in the regular expression matches events arriving at a different input port of the interface and the interleaved actions may include the emitting of events at specified output ports of the interface.

19. The system as in claim 18, wherein said code generator generates a transition table for a finite-state machine recognizing the regular expression, each entry in the transition table specifying the action to be performed and a new state upon the arrival of an event matching a particular alphabet symbol of the regular expression while the finite-state machine is in a specified old state.

20. The system as in claim 18, wherein said code generator generates a representation of a stateful data structure with an operation for processing an input event as specified by the regular expression.

21. The system as in claim 10, wherein said model of a composite component includes the specification of a state machine that executes transitions to various states in response to arriving events.

22. The system as in claim 9, wherein said integrated development units includes an integrated development environment (IDE).

23. The system as in claim 9, wherein said tool units includes one or more domain controllers to administer the run-time platforms.

24. The system as in claim 9, wherein tool units includes one or more library servers in which said one ore more components are stored.

25. The system as in claim 23, wherein said tool units includes a palette from which icons representing component interfaces can be dragged and dropped onto the canvas of a graphical editor being used to construct a composite component model, to specify that the subcomponent interfaces of the composite component model include those represented by the dragged and dropped icons
